(19) United States
(12) Patent Application Publication
(10) Pub. No.: US 2013/0187832 A1
(43) Pub. Date: Jul. 25, 2013

(54) DISPLAY APPARATUS AND METHOD FOR CONTROLLING THE SAME

(71) Applicant: SAMSUNG ELECTRONICS CO., LTD., Suwon-si (KR)

(72) Inventor: Min-suk SONG, Suwon-si (KR)

(73) Assignee: SAMSUNG ELECTRONICS CO., LTD., Suwon-si (KR)

(21) Appl. No.: 13/743,696

(22) Filed: Jan. 17, 2013

(30) Foreign Application Priority Data
Jan. 20, 2012 (KR) 10-2012-0006930

(51) Int. Cl. G09G 5/12

(52) U.S. Cl. CPC G09G 5/12
USPC 345/1.3

(57) ABSTRACT

A method for controlling a display apparatus being used in conjunction with a tiled display system is provided. The method for controlling a display apparatus includes receiving contents from a host device, and when a reproduction preparation of the received contents has been completed, transmitting a completion message to the host device, and if a command to reproduce the contents is received from the host device, reproducing the contents based on sync information received from the host device.

### CROSS-REFERENCE TO RELATED APPLICATIONS

This application claims priority from Korean Patent Application No. 2012-0006930, filed in the Korean Intellectual Property Office on Jan. 20, 2012, the disclosure of which is incorporated herein by reference in its entirety.

### BACKGROUND

1. Field

Aspects of the present inventive concept relate to a display apparatus and a method for controlling the same, and more particularly, to a display apparatus which constitutes a tiled display system and a method for controlling the same.

2. Description of the Related Art

Recently, in conjunction with the continued development of electronic technology, a Liquid Crystal Display (LCD) which is thin and light and requires less power as compared to a Cathode Ray Tube (CRT) has gained much attention.

However, there is a limit to realizing a large-sized LCD, and thus, a tiled display system has been developed and used to overcome such a defect of LCD technology.

The tiled display system enlarges and displays one image in a plurality of display apparatuses so as to allow a user to view the image on the screen at a first glimpse, and it has been used widely in various fields.

However, the tiled display system requires synchronization of images displayed in a plurality of display apparatuses as one screen is realized through the use of the plurality of display apparatuses.

### SUMMARY

Aspects of the present inventive concept relate to a display apparatus which synchronizes a plurality of display apparatuses used in conjunction with a tiled display system and a method for controlling the same.

A method for controlling a display apparatus used in conjunction with a tiled display system, according to an exemplary embodiment, includes receiving contents from a host device, then if a reproduction preparation of the received contents has been completed, transmitting a completion message to the host device, and if a command to reproduce the contents is received from the host device, reproducing the contents based on sync information received from the host device.

The transmitting a completion message to the host device may include transmitting the completion message to the host device when a decoding of a first image relating to the received contents has been completed.

The command to reproduce the contents may be received after a respective completion message is received by the host device from each of a plurality of display apparatuses being used in conjunction with the tiled display system.

The sync information may include information relating to a system clock employed by the host device.

The sync information may be received by the display apparatus as a result of a transmission of the sync information by the host device or in response to a request message transmitted to the host device by the display apparatus.

The method, according to an exemplary embodiment, may further include: if reproduction of the contents is delayed with reference to the sync information, calculating an amount of delay and transmitting information relating to the calculated amount of delay to the host device, and the sync information may be adjusted based on the information relating to the calculated amount of delay, and the adjusted sync information may be transmitted to each of a plurality of display apparatuses being used in conjunction with the tiled display system.

The method, according to an exemplary embodiment, may further include: if a search command to change a reproduction location of the contents is received and a decoding of an image at the changed reproduction location has been completed, retransmitting the completion message to the host device.

The command to reproduce the contents may be received after a completion message in accordance with the search command is received by the host device from each of a plurality of display apparatuses being used in conjunction with the tiled display system.

The search command may include a command to change a reproduction location of the contents at a predetermined time interval.

The reproducing the contents may include outputting an image corresponding to the changed reproduction location at a frame frequency which is inversely proportional to the predetermined time interval.

In another aspect, a display apparatus used in conjunction with a tiled display system, according to an exemplary embodiment, includes an interface unit which receives contents from a host device, a signal processing unit which performs signal processing to reproduce the received contents, and a control unit which, if a reproduction preparation of the received contents has been completed, controls the interface unit to transmit a completion message to the host device, and if a command to reproduce the contents is received from the host device, controls the signal processing unit to reproduce the contents based on sync information received from the host device.

The control unit may control the interface unit to transmit the completion message to the host device when a decoding of a first image relating to the received contents has been completed.

The command to reproduce the contents may be received after a respective completion message is received by the host device from each of a plurality of display apparatuses being used in conjunction with the tiled display system.

The sync information may include information relating to a system clock employed by the host device.

The sync information may be received by the display apparatus as a result of a transmission of the sync information by the host device or in response to a request message transmitted to the host device by the display apparatus.

The control unit, if reproduction of the contents is delayed with reference to the sync information, may calculate an amount of delay and transmit information relating to the calculated amount of delay to the host device, and the sync information may be adjusted based on the information relating to the calculated amount of delay, and the adjusted sync information may be transmitted to each of a plurality of display apparatuses being used in conjunction with the tiled display system.

The control unit, if a search command to change a reproduction location of the contents is received and a decoding of an image at the changed reproduction location has been completed, may control the interface unit to retransmit the completion message to the host device.

The command to reproduce the contents may be received after a completion message in accordance with the search command is received by the host device from each of a plurality of display apparatuses being used in conjunction with the tiled display system.

The search command may include a command to change a reproduction location of the contents at a predetermined time interval.

The control unit may output an image corresponding to the changed reproduction location at a frame frequency which is inversely proportional to the predetermined time interval.

As such, according to various exemplary embodiments, contents may be reproduced if a command to reproduce the contents is received from a server. Accordingly, an output time of an image in display apparatuses being used in conjunction with a tiled display system may be synchronized.

### BRIEF DESCRIPTION OF THE DRAWINGS

These and/or other aspects and advantages of the present inventive concept will become apparent and more readily appreciated from the following description of exemplary embodiments, taken in conjunction with the accompanying drawings, of which:

FIG. 1 is a view which illustrates an operation of a tiled display system for better understanding of an exemplary embodiment;

FIG. 2 is a block diagram which illustrates a configuration of a display apparatus and an operation of a host device thereof, according to an exemplary embodiment; and

FIG. 3 is a flowchart which illustrates a method for controlling a display apparatus, according to an exemplary embodiment.

### DETAILED DESCRIPTION OF THE EMBODIMENTS

Reference will now be made in detail to exemplary embodiments of the present inventive concept, examples of which are illustrated in the accompanying drawings, wherein like reference numerals refer to like elements throughout. The exemplary embodiments are presented below, in order to describe the present inventive concept by referring to the drawing figures.

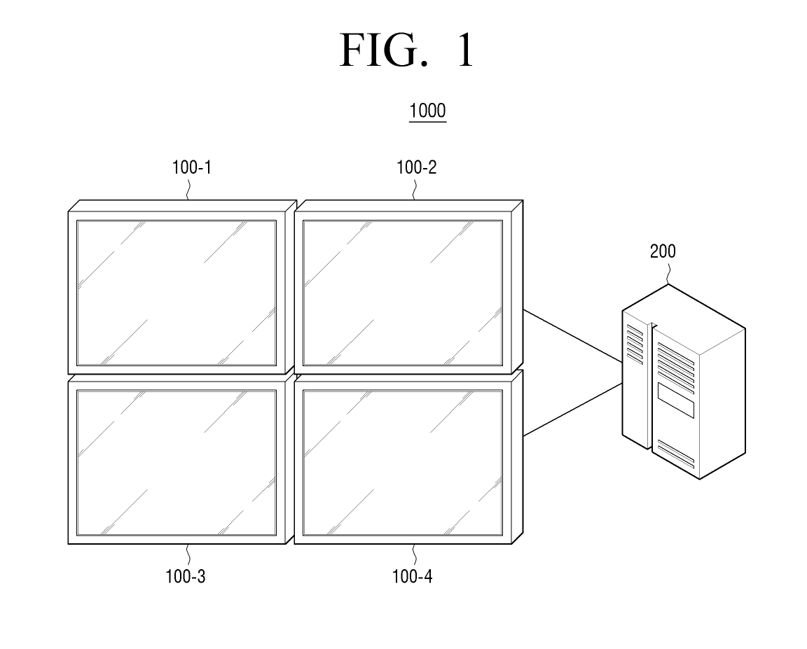

FIG. 1 is a view which illustrates an operation of a tiled display system for better understanding of an exemplary embodiment.

As illustrated in FIG. 1, a tiled display system 1000 generally includes a plurality of display apparatuses 100-1, 100-2, 100-3, and 100-4. For example, the plurality of display apparatuses 100-1, 100-2, 100-3, and 100-4 may be disposed in the form of a 2×2 arrangement. In such an arrangement, two display apparatuses are disposed in a horizontal direction and two display apparatuses are disposed in a vertical direction. However, this is only an example, and the number and disposition of all display apparatuses which constitute a tiled display system may vary.

Meanwhile, each of the display apparatuses 100-1, 100-2, 100-3, and 100-4 receives contents from a host device 200. In particular, the contents are transmitted to each of the display apparatuses 100-1, 100-2, 100-3, and 100-4 in a compressed form and thus, each of the display apparatuses 100-1, 100-2, 100-3, and 100-4 decodes and outputs only a desired image. Accordingly, one image may be enlarged and displayed jointly by a plurality of display apparatuses.

Each of the display apparatuses 100-1, 100-2, 100-3, and 100-4 is synchronized with each other to output contents. In order to achieve such synchronization, in an exemplary embodiment, the host device 200 is configured to control an operation of each of the display apparatuses 100-1, 100-2,10-3, and 100-4. However, this is only an example, and in an alternative exemplary embodiment, one of the display apparatuses 100-1, 100-2, 100-3, and 100-4 may function as a host device to control an operation of the other constituent display apparatuses.

The following text provides a description for a case where the host device 200 controls the display apparatuses 100-1, 100-2, 100-3, and 100-4, for convenience of explanation.

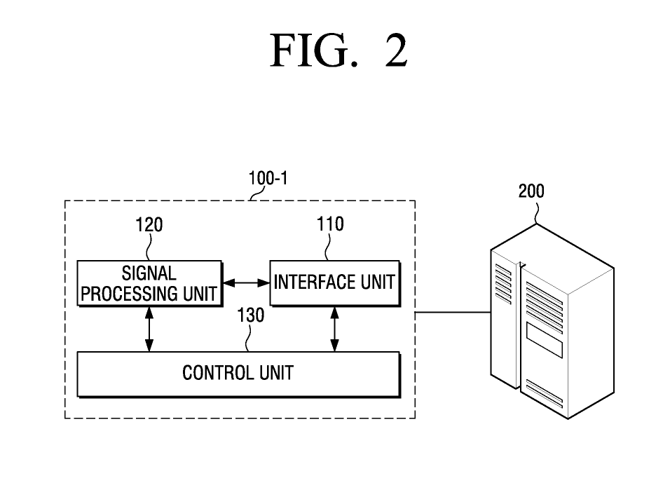

FIG. 2 is a block diagram which illustrates a configuration of a display apparatus and an operation of a host device thereof, according to an exemplary embodiment. Referring to FIG. 2, the display apparatus 100-1 includes an interface unit 110, a signal processing unit 120, and a control unit 130. In particular, the display apparatus 100-1 in FIG. 2 is one of the plurality of display apparatuses constituting a tiled display system illustrated in FIG. 1, and each of the other display apparatuses 100-2, 100-3, and 100-4 may include the same configuration. Hereinafter, FIG. 1 will also be referred to together with FIG. 2 for convenience of explanation.

The interface unit 110 receives contents from the host device 200.

In particular, the interface unit 110 may be connected to the host device 200 in any of various ways, including, for example, via a wire or via a wireless communication method, in order to receive contents including images, such as, for example, a still image or a moving image, from the host device 200.

In an exemplary embodiment, the interface unit 110 may be realized as an interface (not shown) for connection with the host device 200. For example, the interface unit 110 may be connected to the host device 200 by including a D-Sub port, a digital visual interface (DVI) port or a High Definition Multimedia Interface (HDMI), or via a wireless connection such as BlueTooth (BT), Wireless Fidelity (WI-FI), or Zigbee.

Alternatively, the interface unit 110 may be connected to the host device 200 via Internet by including a network interface card (not shown).

Further, the interface unit 110 may receive sync information from the host device 200. In particular, the sync information may be information relating to or provided by a system clock which is used in the host device 200.

The signal processing unit 120 performs signal processing to reproduce received contents. In particular, signal processing, such as decoding, may be performed with respect to the contents which are received in a compressed form from the host device 200 under the control of the control unit 130, and the contents may be processed so that they can be outputted by a display unit (not shown) in the display apparatus 100-1.

More particularly, because the display apparatus 100-1 is being used in conjunction with a tiled display system, the respective signal processing unit 120 in each corresponding display apparatus 100-1, 100-2, 100-3, and 100-4 may decode only an image corresponding to a desired portion of a larger image, and perform scaling or frame-rate conversion so that the decoded image can be outputted by the display unit (not shown).

The control unit 130 is realized as a component such as a central processing unit (CPU), and controls overall operations of the display apparatus 100-1. In particular, if the display apparatus 100-1 is ready for received contents to be reproduced, the control unit 130 may control the interface unit 110 to transmit a completion message to the host device 200, and if a command to reproduce contents is received from the host device 200, the control unit 130 may reproduce the contents received from the host device 200 based on received sync information.

In particular, if decoding of an initial image which constitutes received contents has been completed by the signal processing unit 120, the control unit 130 may control the interface unit 110 to transmit a completion message to the host device 200. In this aspect, the initial image represents the first frame of a video image constituting contents, and more particularly, the initial image may represent the first frame corresponding to a portion of a larger image which a user wishes to output by using the display apparatus 100-1 in conjunction with a tiled display system.

Further, if a respective completion message is received from each of the display apparatuses 100-1, 100-2, 100-3, and 100-4 being used in conjunction with a tiled display system 1000, the host device 200 transmits a command to reproduce contents to each of the plurality of display apparatuses 100-1, 100-2, 100-3, and 100-4.

In particular, if decoding of the first frame of a desired image is completed, each of the display apparatuses 100-1, 100-2, 100-3, and 100-4 being used in conjunction with the tiled display system 1000 transmits a completion message to the host device 200. If a respective completion message is received from each of the plurality of display apparatuses 100-1, 100-2, 100-3, and 100-4, the host device 200 transmits a command to reproduce contents to each of the plurality of display apparatuses 100-1, 100-2, 100-3, and 100-4. Accordingly, each of the plurality of display apparatuses 100-1, 100-2, 100-3, and 100-4 outputs the respective first frame at the same time, regardless of performance of each module constituting the plurality of display apparatuses 100-1, 100-2, 100-3, and 100-4.

Further, the display apparatus 100-1 reproduces contents based on sync information received from the host device 200. In this aspect, the sync information may represent information relating to or provided by a system clock which is used in the host device 200.

In particular, each of the display apparatuses 100-1, 100-2, 100-3, and 100-4 reproduces contents based on a system clock being used by the host device 200 rather than its own respective system clock. Accordingly, each of the display apparatuses 100-1, 100-2, 100-3, and 100-4 may output an image at the same time, according to a respective time stamp which corresponds to each frame of images included within contents.

Each of the display apparatuses 100-1, 100-2, 100-3, and 100-4 may receive sync information from the host device 200 in various ways.

For example, the display apparatus 100-1 may receive sync information which is transmitted from the host device 200, or in response to a request transmitted to the host device from the display apparatus 100-1.

In the case where the display apparatus 100-1 transmits a request, if contents are received via the interface unit 110, the control unit 130 may transmit a request message for sync information to the host device 200, and then receive sync information from the host device 200 in response to the request. Alternatively, if decoding of the first frame has been completed by the signal processing unit 120, the control unit 130 may transmit a request message to the host device 200 via the interface unit 110, and then receive sync information from the host device 200 in response to the request.

Further, if reproduction of contents is delayed with reference to sync information, the control unit 130 may produce information regarding the delayed time, for example, by calculating an amount of delay, and then transmit the information to the host device 200. The reproduction of contents may be delayed in a case where another operation is performed in the display apparatus 100-1, consuming considerable amount of resources in the control unit 130 and accordingly, synchronization with other display apparatuses 100-2, 100-3, and 100-4 would not be performed properly.

In this case, the host device 200 may reproduce or adjust sync information based on the information relating to the delayed time and then transmit the adjusted sync information to each of the plurality of display apparatuses 100-1, 100-2, 100-3, and 100-4 which is being used in conjunction with a tiled display system 1000.

In particular, if the information relating to the delayed time is transmitted from the display apparatus 100-1, the host device 200 may adjust a system clock based on amount of delay and transmit information relating to the adjusted system clock to each of the display apparatuses 100-1, 100-2, 100-3, and 100-4 which is being used in conjunction with the tiled display system 1000. Accordingly, the display apparatuses 100-2, 100-3, and 100-4, but excluding the display apparatus 100-1 for which a reproduction of contents has already been delayed, are thus configured to reproduce contents based on the information relating to the delayed time, and thus, all of the display apparatuses 100-1, 100-2, 100-3, and 100-4 may reproduce contents simultaneously.

For example, suppose that each of the display apparatuses 100-1, 100-2, 100-3, and 100-4 reproduces the respective fifth frame based on a normal system clock. In this case, if the reproduction of contents is delayed in the display apparatus 100-1 and thus, the third frame is outputted, the display apparatus 100-1 transmits the information relating to an amount of delay to the host device 200. The host device 200 then transmits information relating to a recalculated system clock to each of the display apparatuses 100-1, 100-2, 100-3, and 100-4, where the recalculation is based on the information relating to the amount of delay. Accordingly, each of the other display apparatuses 100-2, 100-3, and 100-4 delays an output of the respective fifth frame currently being reproduced until the display apparatus 100-1 outputs the respective fifth frame. If the display apparatus 100-1 outputs the fifth frame, each of the display apparatuses 100-1, 100-2, 100-3, and 100-4 then outputs the next respective frame, which is the sixth frame, simultaneously.

As such, the output speed of an image in each of the other display apparatuses 100-2, 100-3, and 100-4 is delayed and thus, the display apparatus 100-1 may be synchronized with the other display apparatuses 100-2, 100-3, and 100-4 from a time when the display apparatus 100-1 outputs a frame after being delayed.

Further, if the host device 200 receives information relating to a respective delay from each of the display apparatuses 100-2, 100-3, and 100-4, the host device 200 may recalculate sync information based on the respective information relating to the greatest amount of delay in order to synchronize the reproduction between a display apparatus having the greatest amount of delay and the other display apparatuses.

Still further, if a search command to change the reproduction location of contents is received, and a decoding of an image at the changed reproduction location has been completed by the signal processing unit 120, the control unit 130 may retransmit a completion message to the host device 200. In particular, the search command to change the reproduction location of contents may include a search command to reproduce contents at a time which is different from a current reproduction time.

More particularly, the control unit 130 controls the signal processing unit 120 to perform decoding of an image frame corresponding to a reproduction time in accordance with a search command, and if a decoding of the corresponding frame is completed, the control unit may retransmit to the host device 200 a completion message informing that the decoding of an image frame corresponding to a reproduction time in accordance with a search command has been completed. In this case, the control unit 130 may control to stop reproducing contents until a reproduction command is received from the host device 200.

If a subsequent respective completion message in accordance with a search command is received from each of the plurality of display apparatuses 100-1, 100-2, 100-3, and 100-4 which are being used in conjunction with a tiled display system 1000, the host device 200 may transmit a reproduction command regarding contents to each of the plurality of display apparatuses 100-1, 100-2, 100-3, and 100-4. Each of the display apparatuses 100-1, 100-2, 100-3, and 100-4 reproduces contents if the reproduction command is received from the host device 200.

Accordingly, even in the case where a search command is received, an image frame may be outputted simultaneously at a time corresponding to the search command regardless of performance of each module constituting each of the display apparatuses 100-1, 100-2, 100-3, and 100-4.

In one aspect, in the above exemplary embodiment, the search command may include a command to change a reproduction location of contents at a predetermined time interval. For example, the search command may include a command to change a reproduction location of contents every two minutes or every four minutes, and/or at any such time intervals which may be set by a user.

If a search command to change a reproduction location of contents at a predetermined time interval is received, the control unit 130 may output an image corresponding to the changed reproduction location at a frame frequency which is inversely proportional to the predetermined time interval. In particular, the control unit 130 may output an image such that the greater the time interval corresponding to a reproduction location of contents, the shorter the output time of each successive frame which composes the image.

For example, suppose that the display apparatus 100-1 outputs an image corresponding to four minutes of current reproduction time, and respective search commands specifying a first time interval of two minutes and a second time interval of four minutes are received.

If the search command having the first time interval is received, the control unit 130 outputs an image by changing a reproduction location of contents at every two minutes from the current output point, i.e., at the 6 minute mark, the 8 minute mark, the 10 minute mark, and so forth. Accordingly, the control unit may output a corresponding frame of an image at each of the 6 minute mark, the 8 minute mark, the 10 minute mark, and so forth, for four seconds.

Instead, if the search command having the second time interval is received, the control unit 130 outputs an image by changing a reproduction location of contents at every four minutes from the current output point, i.e., at the 8 minute mark, the 12 minute mark, the 16 minute mark, and so forth.

In this case, because the second time interval is double the length of the first time interval, the control unit 130 may output an image corresponding to the changed reproduction location at a frame frequency which is two times faster, or shorter, than when the search command having the first time interval is received. Accordingly, the control unit 130 outputs a corresponding frame of an image at each of the 8 minute mark, the 12 minute mark, the 16 minute mark, and so forth, for two seconds.

In this aspect, the greater a length of a predetermined time interval, the shorter the display of the corresponding frame of an image is outputted at a changed reproduction location, and thus, a multi-speed playback effect may be provided to a user.

Further, in the above exemplary embodiment, each of the display apparatuses 100-1, 100-2, 100-3, and 100-4 may reproduce contents if a reproduction command regarding contents is received from the host device 200.

Accordingly, once a decoding of an image corresponding to a reproduction location which is changed at a predetermined time interval has been completed, each respective one of the display apparatuses 100-1, 100-2, 100-3, and 100-4 retransmits a completion message to the host device 200 at every reproduction location. If a respective completion message is received from each of the plurality of the display apparatuses 100-1, 100-2, 100-3, and 100-4, the host device 200 transmits a reproduction message regarding contents to each of the plurality of display apparatuses 100-1, 100-2, 100-3, and 100-4 at every reproduction location.

In particular, in the above exemplary embodiment, the host device 200 controls operations of each of the display apparatuses 100-1, 100-2, 100-3, and 100-4, but this is only an example. In an alternative exemplary embodiment, one of the display apparatuses being used in conjunction with a tiled display system may control operations of other display apparatuses. The following text provides a description of a case where the display apparatus 100-1 serves as a host device, for convenience of explanation.

The control unit 130 of display apparatus 100-1 provides contents and sync information to other display apparatuses 100-2, 100-3, and 100-4. In particular, the sync information that the display apparatus 100-1 uses may be a system clock.

If a respective completion message regarding reproduction preparation is received from each of the other display apparatuses 100-2, 100-3, and 100-4, the control unit 130 controls the interface unit 110 to transmit a command to reproduce contents to each of the plurality of display apparatuses 100-2, 100-3, and 100-4.

Further, if reproduction of contents is delayed in the display apparatus 100-2 and information relating to an amount of delay is received, the control unit 130 may recalculate sync information based on the information relating to the amount of delay and then transmit the recalculated sync information to each of the other display apparatuses 100-2, 100-3, and 100-4 via the interface unit 110.

Still further, if a search command is executed and a respective completion message is received from each of the other display apparatuses 100-2, 100-3, and 100-4 in accordance with the search command, the control unit may transmit a command to reproduce contents to each of the other display apparatuses 100-2, 100-3, and 100-4.

Accordingly, one of a plurality of display apparatuses being used in conjunction with a tiled display system may serve as a host device to control the other display apparatuses.

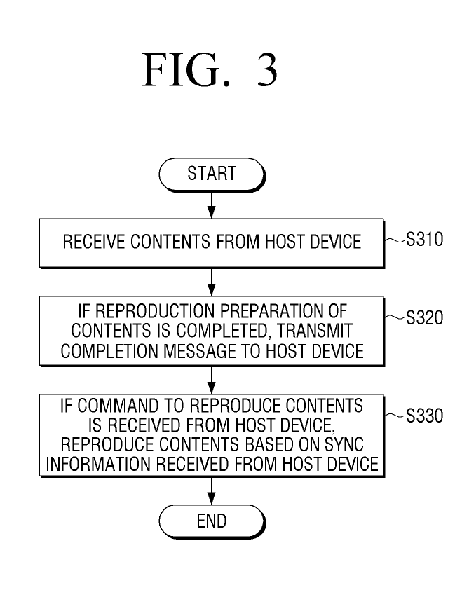

FIG. 3 is a flowchart which illustrates a method for controlling a display apparatus, according to an exemplary embodiment. In particular, FIG. 3 is a flowchart which illustrates a method for controlling display apparatuses being used in conjunction with a tiled display system by which each display apparatus may be controlled by a single host device. However, this is only an example, and in an alternative exemplary embodiment, one of a plurality of display apparatuses being used in conjunction with a tiled display system may control operations of the other display apparatuses.

First, contents are received from a host device (operation S310). In particular, the contents may include images, such as, for example, a still image and/or a moving image.

Next, if reproduction preparation regarding the received contents has been completed, a completion message is transmitted to a host device (operation S320). In particular, if a decoding of the first image relating to the received contents has been completed, a completion message may be transmitted to the host device.

In this case, if a respective completion message is received from each of a plurality of display apparatuses being used in conjunction with a tiled display system, the host device may transmit a command to reproduce contents to each of the plurality of display apparatuses. Accordingly, the output point of time of the first respective frame to be displayed on each of the plurality of display apparatuses may be synchronized.

Next, if a command to reproduce contents is received from the host device, the contents are reproduced based on the sync information received from the host device (operation S330). In particular, the sync information may include information relating to or provided by a system clock employed by the host device. Accordingly, each display apparatus reproduces contents with reference to the same clock and thus, may output a respective frame of an image at the same point of time in accordance with a time stamp which corresponds to each image frame.

Further, a display apparatus may receive sync information as a result of a transmission of the sync information by the host device, or may receive sync information in a response to a request for the sync information transmitted to the host device by the display apparatus.

Still further, in the exemplary embodiment, the method may further include that, if reproduction of contents is delayed with reference to sync information, an amount of delay may be calculated, and information relating to the calculated amount of delay may be transmitted to a host device. In this case, the host device may recalculate or adjust sync information based on the information relating to the calculated amount of delay, and transmit the adjusted sync information to each of a plurality of display apparatuses which are being used in conjunction with a tiled display system so as to synchronize the output time of the display apparatus for which reproduction has been delayed with the corresponding output times of the other display apparatuses.

Still further, in the exemplary embodiment, the method may further include that, if a search command is received and a decoding of an image has been completed at a changed reproduction location, a completion message may be retransmitted to the host device. In this case, if a respective completion message in accordance with the search command is received from each of a plurality of display apparatuses being used in conjunction with a tiled display system, the host device may broadcast a command to reproduce contents to each of the plurality of display apparatuses so as to cause the plurality of display apparatuses to reproduce an image at a changed reproduction location simultaneously in accordance with the search command.

In particular, the search command may include a command to change a reproduction location of contents at a predetermined time interval. More particularly, an image corresponding to a change reproduction location may be outputted at a frame frequency which is inversely proportional to the predetermined time interval.

The description regarding the above exemplary embodiments has already been provided above and thus, further description and illustrated will not be provided.

Further, a program to perform a method according to the various exemplary embodiments described above may be stored and used in various recording media.

Specifically, a program code for performing the above-mentioned controlling method may be stored in various types of recording media readable by a terminal, such as, for example, Random Access Memory (RAM), flash memory, Read Only Memory (ROM), Erasable Programmable ROM (EPROM), Electronically Erasable and Programmable ROM (EEPROM), register, hard disk drive (HDD), removable disk, memory card, USB memory, and compact disk—ROM (CD-ROM).

Although a few exemplary embodiments according to the present inventive concept have been shown and described, it will be appreciated by those skilled in the art that changes may be made in these exemplary embodiments without departing from the principles and spirit of the present disclosure, the scope of which is defined in the claims and their equivalents.

What is claimed is:

1. A method for controlling a display apparatus used in conjunction with a tiled display system, the method comprising:
receiving contents from a host device;
if a reproduction preparation of the received contents has been completed, transmitting a completion message to the host device; and
if a command to reproduce the contents is received from the host device, reproducing the contents based on sync information received from the host device.

2. The method as claimed in claim 1, wherein the transmitting a completion message to the host device comprises transmitting the completion message to the host device when a decoding of a first image relating to the received contents has been completed.

3. The method as claimed in claim 1, wherein the command to reproduce the contents is received after a respective completion message is received by the host device from each of a plurality of display apparatuses being used in conjunction with the tiled display system.

4. The method as claimed in claim 1, wherein the sync information includes information relating to a system clock employed by the host device.

5. The method as claimed in claim 1, wherein the sync information is received by the display apparatus as a result of a transmission of the sync information by the host device or in response to a request message transmitted to the host device by the display apparatus.

6. The method as claimed in claim 1, further comprising:
if reproduction of the contents is delayed with reference to the sync information, calculating an amount of delay and transmitting information relating to the calculated amount of delay to the host device,
wherein the sync information is adjusted based on the information relating to the calculated amount of delay, and the adjusted sync information is transmitted to each of a plurality of display apparatuses being used in conjunction with the tiled display system.

7. The method as claimed in claim 1, further comprising:
if a search command to change a reproduction location of the contents is received and a decoding of an image at the changed reproduction location has been completed, retransmitting the completion message to the host device.

8. The method as claimed in claim 7, wherein the command to reproduce the contents is received after a completion message in accordance with the search command is received by the host device from each of a plurality of display apparatuses being used in conjunction with the tiled display system.

9. The method as claimed in claim 8, wherein the search command includes a command to change a reproduction location of the contents at a predetermined time interval.

10. The method as claimed in claim 9, wherein the reproducing the contents comprises outputting an image corresponding to the changed reproduction location at a frame frequency which is inversely proportional to the predetermined time interval.

11. A display apparatus used in conjunction with a tiled display system, comprising:
an interface unit which receives contents from a host device;
a signal processing unit which performs signal processing to reproduce the received contents; and
a control unit which, if a reproduction preparation of the received contents has been completed, controls the interface unit to transmit a completion message to the host device, and if a command to reproduce the contents is received from the host device, controls the signal processing unit to reproduce the contents based on sync information received from the host device.

12. The apparatus as claimed in claim 11, wherein the control unit controls the interface unit to transmit the completion message to the host device when a decoding of a first image relating to the received contents has been completed.

13. The apparatus as claimed in claim 11, wherein the command to reproduce the contents is received after a respective completion message is received by the host device from each of a plurality of display apparatuses being used in conjunction with the tiled display system.

14. The apparatus as claimed in claim 11, wherein the sync information includes information relating to a system clock employed by the host device.

15. The apparatus as claimed in claim 11, wherein the sync information is received by the display apparatus as a result of a transmission of the sync information by the host device or in response to a request message transmitted to the host device by the display apparatus.

16. The apparatus as claimed in claim 11, wherein if reproduction of the contents is delayed with reference to the sync information, the control unit calculates an amount of delay and transmits information relating to the calculated amount of delay to the host device,
wherein the sync information is adjusted based on the information relating to the calculated amount of delay, and the adjusted sync information is transmitted to each of a plurality of display apparatuses being used in conjunction with the tiled display system.

17. The apparatus as claimed in claim 11, wherein if a search command to change a reproduction location of the contents is received and a decoding of an image at the changed reproduction location has been completed, the control unit controls the interface unit to retransmit the completion message to the host device.

18. The apparatus as claimed in claim 17, wherein the command to reproduce the contents is received after a completion message in accordance with the search command is received by the host device from each of a plurality of display apparatuses being used in conjunction with the tiled display system.

19. The apparatus as claimed in claim 18, wherein the search command includes a command to change a reproduction location of the contents at a predetermined time interval.

20. The apparatus as claimed in claim 19, wherein the control unit outputs an image corresponding to the changed reproduction location at a frame frequency which is inversely proportional to the predetermined time interval.
